(19) United States
(12) Patent Application Publication
(10) Pub. No.: US 2010/0257745 A1
(43) Pub. Date: Oct. 14, 2010

(54) SPIRIT LEVEL

(76) Inventor: Paul Andrew Sparrow, Dorset (GB)

Correspondence Address: BROOKS KUSHMAN P.C., 1000 TOWN CENTER, TWENTY-SECOND FLOOR, SOUTHFIELD, MI, 48075, US

(21) Appl. No.: 12/747,268

(22) PCT Filed: Dec. 8, 2008
(86) PCT No.: PCT/GB08/04048

§ 371 Date: Jun. 10, 2010

(30) Foreign Application Priority Data
Dec. 10, 2007 (GB) 0724065.8

(51) Int. Cl. G01C 9/26

(52) U.S. Cl. 33/382; 33/379

(57) ABSTRACT

A spirit level comprises a planar base that functions, with the level in a first orientation, as a first level face which rests, in use, on a surface of an item whose level is to be determined. The level is further provided with leveling means comprising first and second vials each filled with a liquid to form a bubble, the longitudinal axis of the first vial being substantially parallel to the plane of the planar base, the longitudinal axis of the second vial being substantially perpendicular to the longitudinal axis of the first vial. Optical means are provided to provide an image of one of the vials such that the level of the surface can be determined about two axes, with the planar base resting on the surface of the item whose level is to be determined.

The present invention relates to a spirit level.

Our earlier international patent application PCT/GB2007/001324 filed 10 Apr. 2007 relates to a spirit level comprising optical means to provide an image of a bubble and indicia of a vial such that the position of the bubble within the vial can be determined from a number of different viewing angles.

We are also aware of a prior UK patent GB 2321520 B of Zugel Duane which describes a spirit level provided with a tubular vial that is perpendicular to the level face, that is, the face of the level that rests on a surface of an item to be levelled. A mirror is provided at an angle to the vial such that when the spirit level is used in a plumb orientation, that is, in a vertical orientation, the position of the bubble within the vial can be viewed at a viewing angle perpendicular to the level face, through a small window formed in the top face of the level, that is, the face parallel with but opposite to the level face.

A problem with the level of patent GB 2321520 B is that the viewing window is relatively small and the user can still only see the image of the vial when looking at the top face and window directly with a viewing angle exactly perpendicular to the plane of the level face, that is in a direction exactly aligned with the longitudinal axis of the vial, in a viewing plane parallel to the level face. The level of GB 2321520 B also cannot be used in a horizontal orientation with the vial parallel with the plane of the surface of the item to be levelled and parallel to the viewing angle. The level of GB 2321520 B additionally does not enable two vials to be viewed from a single viewing angle and thus does not enable the level of the item to be determined simultaneously about two axes, for example left to right, and front to back, whilst viewing the level from a single viewing angle.

The current application stems from some development work done in improving the level of our original international patent application, and overcoming various problems with the level of GB 2321520 B.

According to a first aspect of the invention there is provided a spirit level comprising a planar base that functions, with the level in a first orientation, as a first level face which rests, in use, on a surface of an item whose level is to be determined, the level being further provided with levelling means comprising first and second vials each filled with a liquid to form a bubble, the longitudinal axis of the first vial being substantially parallel to the plane of the planar base, the longitudinal axis of the second vial being substantially perpendicular to the longitudinal axis of the first vial, optical means being provided to provide an image of one of the vials such that the level of the surface can be determined about two axes, with the planar base resting on the surface of the item whose level is to be determined.

In one embodiment the level of the surface can be determined about two axes when the level is viewed in a direction parallel to the axis of the second vial, that is, in a direction parallel with the plane of the level face but perpendicular to the longitudinal axis of the level. In other embodiments, other viewing angles are envisaged that may be inclined to the plane of the level face and/or the longitudinal axis of the level.

Preferably the level further comprising a planar front that functions, with the level in a second orientation, as a second level face for resting, in use, on a surface of an item whose level is to be determined.

Preferably the optical means is such that the level of the item about two axes can be determined simultaneously from a single viewing angle, both when the level is in a horizontal orientation, and when the level is in a vertical orientation.

The optical means may comprise a prism. Alternatively, or additionally, the optical means may comprise a mirror.

Preferably the mirror is multi-faceted.

Preferably the faces of the mirror comprise a plurality of intersecting faces.

Preferably at least one face is inclined to the plane of the planar base, and to the plane of the planar front of the level.

Preferably at least one face is inclined at substantially 45° to the plane of the planar base, and at substantially 45° to the plane of the planar front of the level.

Preferably at least one face is substantially perpendicular to the plane of the planar base and inclined relative to the plane of the planar front of the level.

Preferably at least one face is substantially perpendicular to the plane of the planar base and inclined at substantially 45° relative to the plane of the front of the level.

Preferably at least one face is substantially perpendicular to the plane of the front of the level and inclined relative to the plane of the base of the level.

Preferably at least one face is substantially perpendicular to the plane of the front of the level and inclined at substantially 45° relative to the plane of the base of the level.

Preferably the mirror comprises at least one planar face.

The mirror may comprise at least one curved face.

Preferably the optical means includes a protective cover through which the vials can be viewed.

The cover may comprise a lens.

Preferably the rear of the level is recessed so as to define a first rear planar portion the plane of which is substantially parallel with the plane of the front of the level, and a second rear planar portion the plane of which is perpendicular to the plane of the front of the level, the rear planar portions each comprising level faces operative to rest against a surface of an item to be levelled to enable the level of the item to be determined.

Preferably the levelling means comprises a third vial, the longitudinal axis of which is perpendicular to the longitudinal axes of the first and second vials.

Preferably the longitudinal axis of the third vial is perpendicular to the plane of the base of the level.

Preferably the vials are mounted on a common support such that the longitudinal axes of the vials intersect at the support. In another embodiment, each vial may be spaced along the longitudinal axis of the level so as to be relatively spaced apart, the optical means then comprising a respective optical sub means for each vial.

Preferably the common support comprises mounting means operative to mount the support on the level.

Preferably the level is formed with a protrusion, the mounting means of the cylindrical support comprising a clip that clips onto the protrusion.

Preferably the protrusion is barbed so as to be operative to enable the clip to be pressed onto the protrusion but to resist removal of the clip from the protrusion.

Preferably the protrusion comprises a spine extending along the level in a direction parallel with the longitudinal axis of the level.

Preferably each vial is a different colour. It may be the vial casing is coloured, or the liquid contained in the vial.

Preferably the levelling means comprises a cradle mounted on the level, the cradle supporting the levelling means and the optical means.

Preferably the cradle comprises a clip operative to clip onto the protrusion to mount the cradle on the level.

Preferably the level comprises a cut-out formed in the planar front and the top of the level, the cradle being mounted in the cut-out.

According to a second aspect of the invention there is provided a spirit level comprising a level face which rests, in use, on a surface of an item whose level is to be determined, the level further comprising levelling means comprising a vial filled with a liquid to form a bubble, the level face being recessed so as to define a first planar portion and a second planar portion the plane of which is perpendicular to the plane of the first planar portion, the planar portions each comprising level faces operative to rest against a surface of an item to be levelled to enable the level of the item to be determined.

According to a third aspect of the invention there is provided a spirit level comprising a planar base that functions as a level face which rests, in use, on a surface of an item whose level is to be determined, the level being further provided with levelling means comprising a vial filled with a liquid to form a bubble, the longitudinal axis of the vial being substantially parallel to the planar base and perpendicular to the longitudinal axis of the level, optical means being provided to provide an image of the vial when the level is viewed in a direction parallel with the longitudinal axis of the vial.

Other aspects of the present invention may include any combination of the features or limitations referred to herein.

The present invention may be carried into practice in various ways, but embodiments will now be described by way of example only with reference to the accompanying drawings in which:

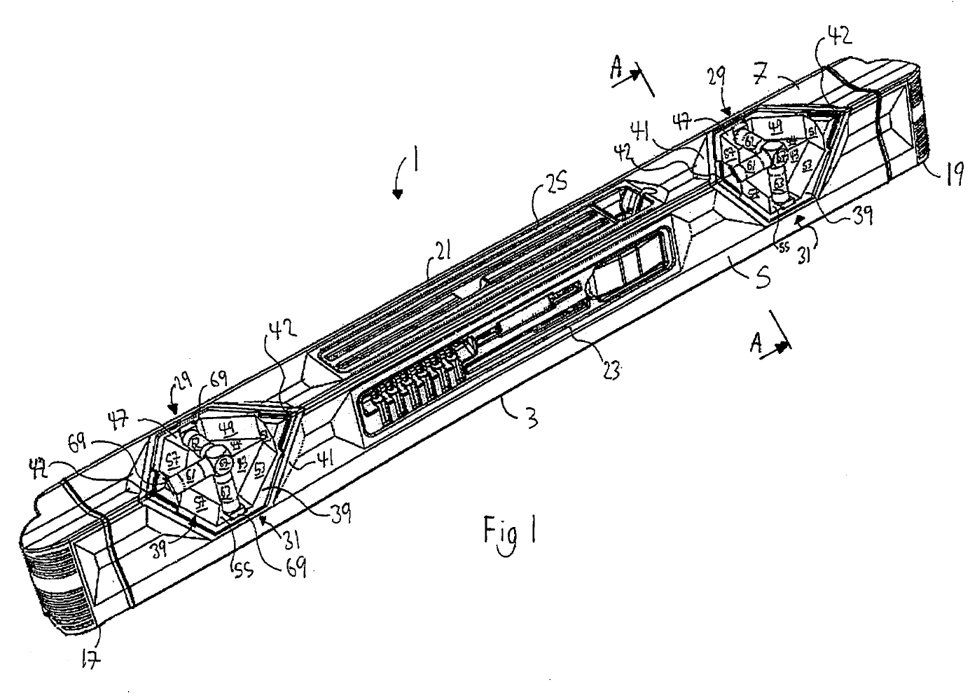

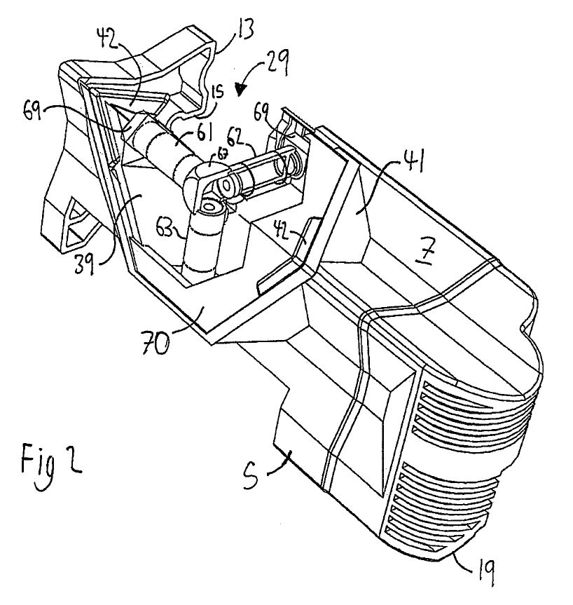

FIG. 1 is a perspective view of a spirit level in accordance with the present invention;

FIG. 2 is an enlarged perspective view from one end of an end portion of the level of FIG. 1 with parts of the level removed for clarity;

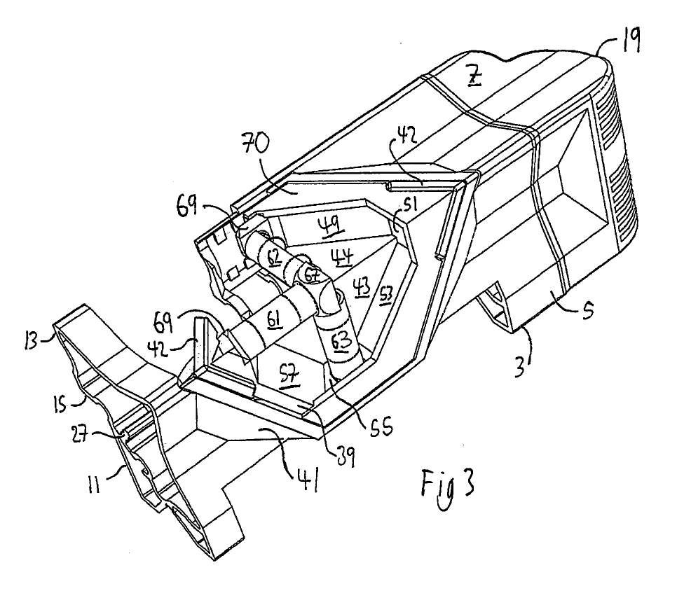

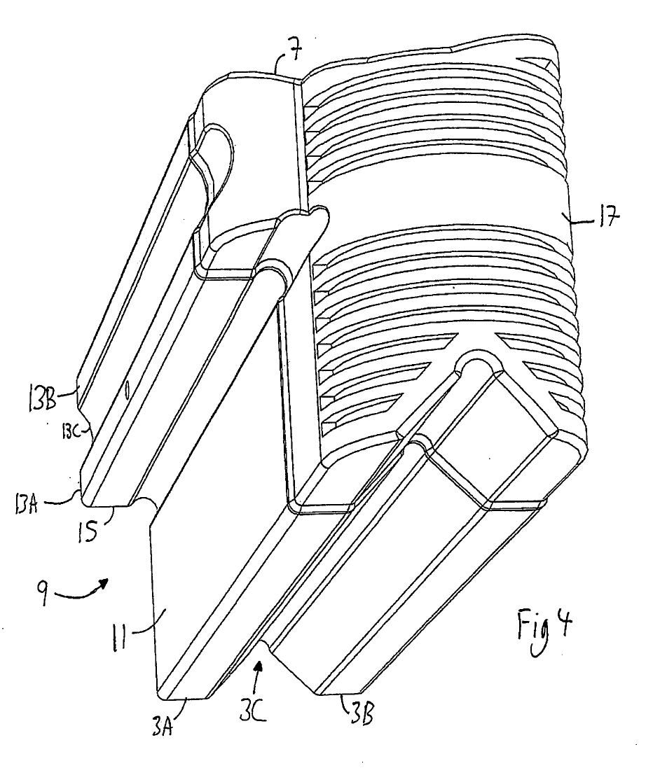

FIG. 3 is an enlarged perspective view from the middle of the level of the end portion of the level of FIG. 2 with parts of the level removed for clarity;

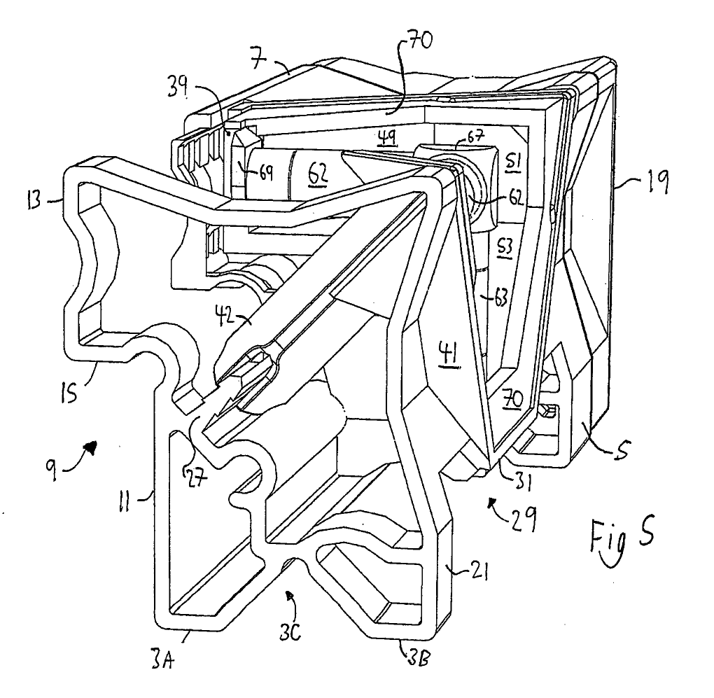

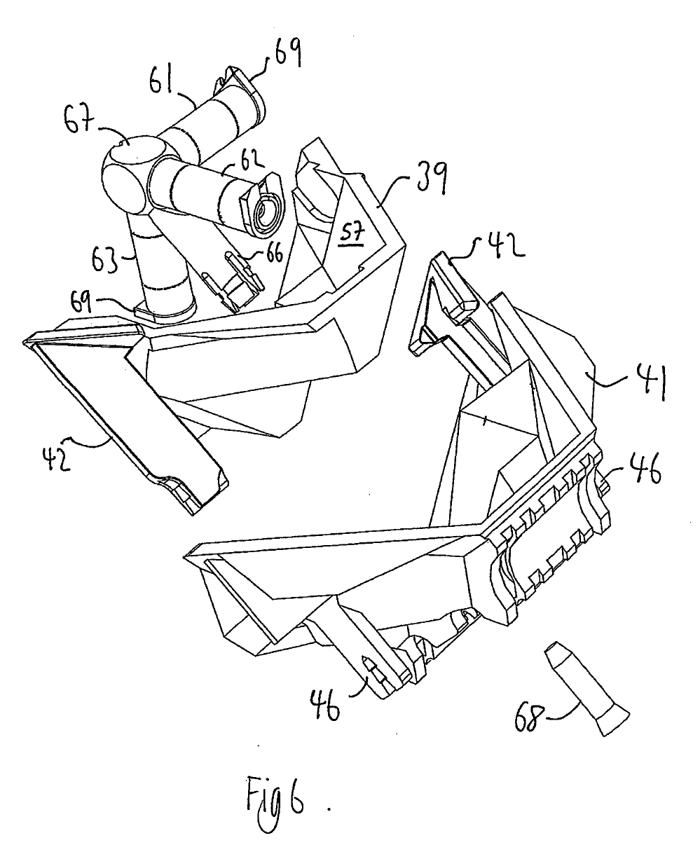

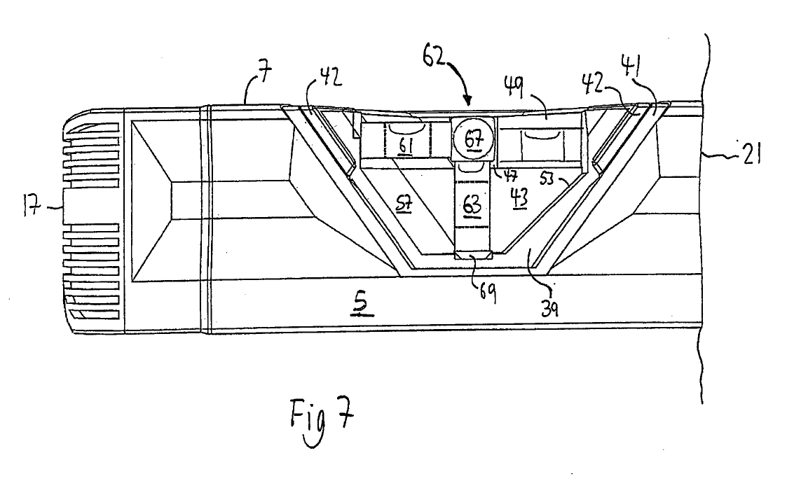

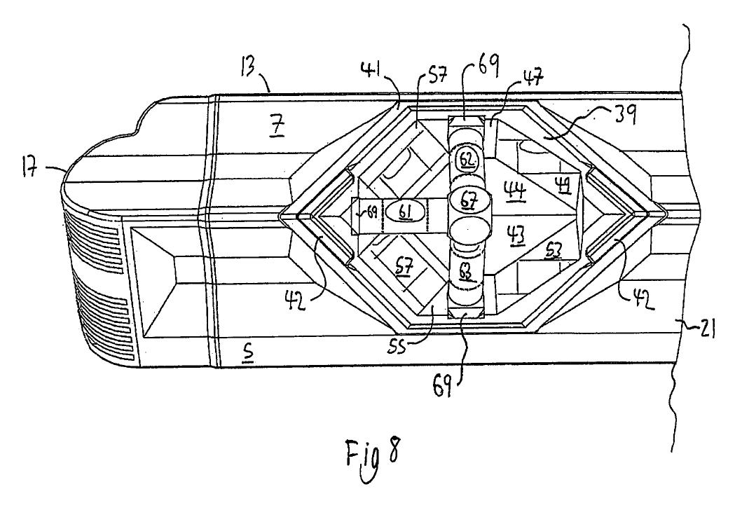

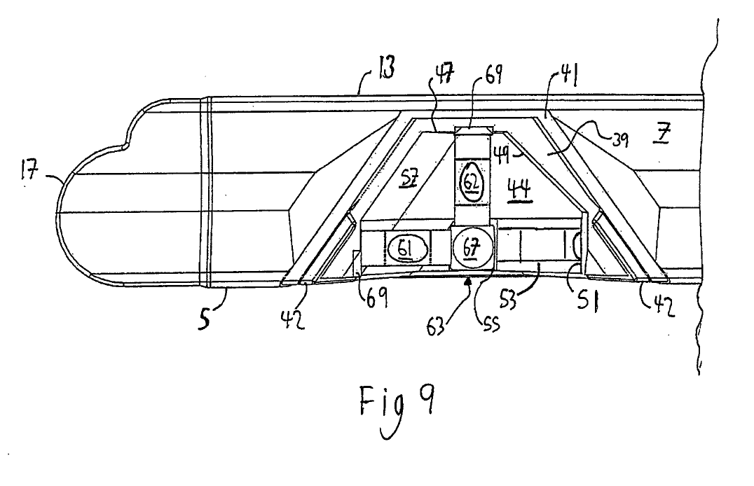

FIG. 4 is an enlarged perspective view on one end of the level of FIGS. 1 to 3;

FIG. 5 is an enlarged perspective sectional view through line A-A of FIG. 1, with parts of the level removed for clarity;

FIG. 6 is an enlarged, exploded perspective view of a vial assembly comprising part of the level of FIGS. 1 to 5;

FIG. 7 is a view from the front of an opposite end portion of the level of FIGS. 1 to 6 with the level in a first horizontal orientation;

FIG. 8 is an enlarged perspective view from the front and top of the opposite end portion of FIG. 7 with the level in a first horizontal orientation;

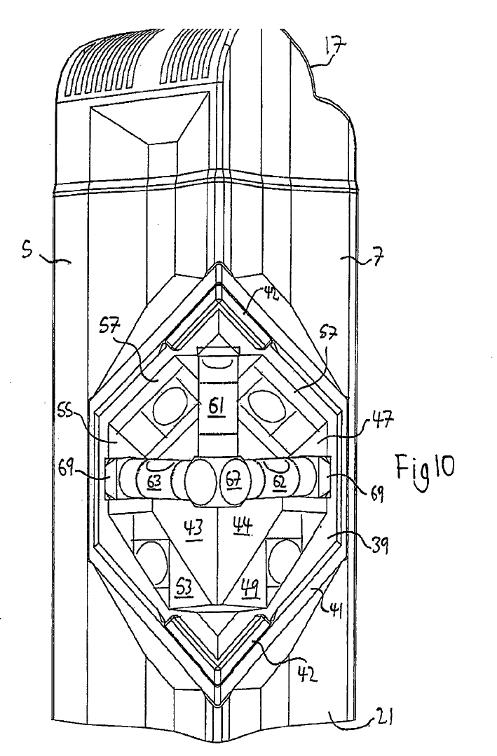

FIG. 9 is a view from the top of the opposite end portion of FIGS. 7 and 8 with the level in a first horizontal orientation;

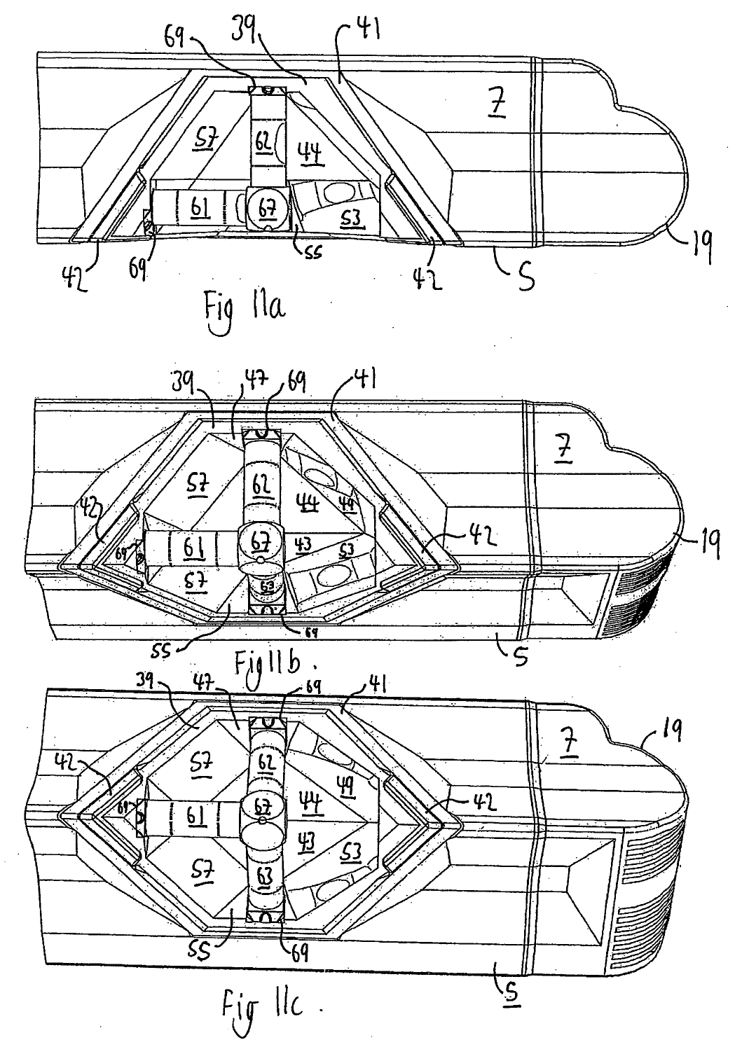

FIG. 10 is an enlarged perspective view from the front and top of the opposite end portion of FIGS. 7 to 9 with the level in a plumb orientation;

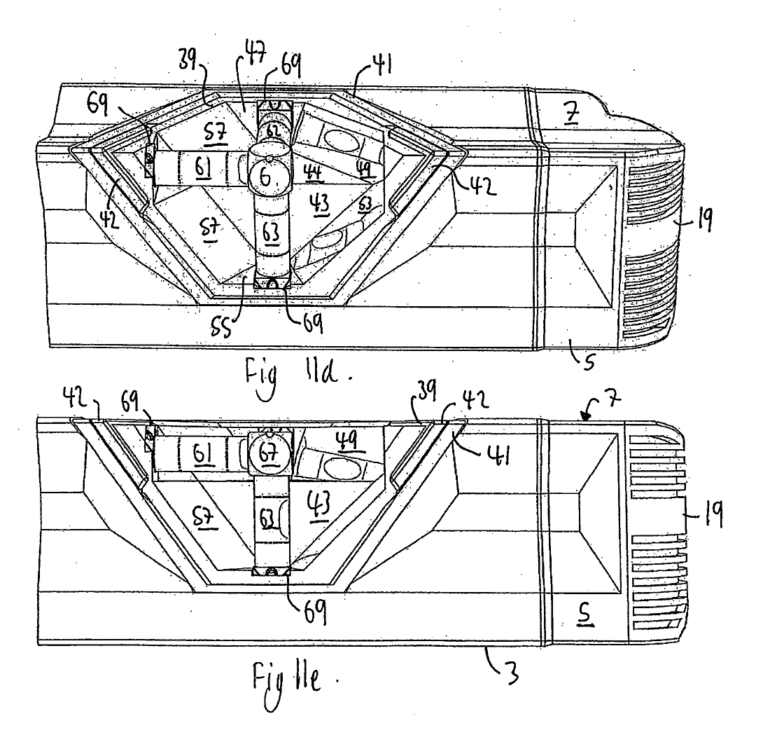

FIGS. 11a to 11e are perspective views of a modified level in accordance with the present invention, looking down at viewing angles beginning from 90° above the top of the level, to 90° to the front of the level, the viewing angle of each view being 22.5° from the last.

Referring to the Figures, a spirit level 1 is of generally oblong form and comprises a machined base 3, a machined planar front 5, and a machined planar top 7.

The base 3 comprises two machined, planar base strips 3A, 3B intermediate which is an inverted machined ‘V’ shaped groove 3C. The plane of the base strips 3A, 3B is parallel with the plane of the top 7. The plane of the base strips 3A, 3B and the plane of the top 7 are perpendicular to the plane of the front 5.

The rear of the level 1, as can best be seen with reference to FIG. 4, is recessed 9 so as to comprise a machined planar lower portion 11 extending perpendicularly from the base 3, and two parallel machined planar upper portions 13A, 13B that are spaced further from the horizontal axis of the level 1 than the lower wall 11 by an intermediate perpendicular portion 15 the plane of which is parallel with the plane of the base strips 3A, 3B. A finger grip channel 13C is intermediate the planar portions 13A, 13B.

The level 1 comprises two opposed ends 17, 19 which in this example comprise ribbed end caps formed from a shock absorbent material such as a rubber or rubber like material.

The part 21 of the level 1 intermediate the two ends 17, 19 comprises storage means for storing various items. In this example the storage means comprises an oblong cavity 23 in the front 5, and an oblong cavity 25 in the top 7. The cavity 23 stores a selection of screwdriver heads and a screwdriver handle for use with the heads. The cavity 25 stores a selection of writing instruments which in this example comprise pencils.

Each cavity 23, 25 may be magnetic so as to retain loose drill bits or screws for example, and/or may be fitted with a lid.

The level 1 comprises a substantially hollow extrusion defined by the base 3A, 3B, 3C, front 5, top 7 and rear portions 11, 13A, 13B, 13C, 15. The level 1 comprises a number of internal reinforcing formations and cross pieces along the length of the level 1. A mounting protrusion comprising a barbed spine 27 projects from and along the length of one of the lower reinforcing formations at the rear of the inside of the level 1 at about 45° to the plane of the lower rear portion 11.

The level 1 comprises two cut-outs 29 formed between the intermediate part 21 and respective ends 17, 19 of the level 1, the barbed spine 27 being exposed to the cut outs 29. Each cut out 29 is formed in the front 5 and top 7 of the level 1. Levelling means is provided comprising a respective vial assembly 31 mounted in each cut out 29.

The two vial assemblies 31 are identical in this example and comprise levelling means comprising three vials 61, 62, 63 and optical means to provide an image of the vials 61, 62, 63, the optical means in this example comprising a multi faceted mirrored dish 39.

Each vial assembly 31 comprises a cup shaped cradle 41. Two spaced apart barbed clips 42 are provided to engage the mirrored dish 39 to clip the mirrored dish 39 onto the cradle 41 or to pass through the cradle 41 and clip directly onto the spine 27. The cradle 41 is provided with its own spaced apart barbed clips 46 that clip the cradle 41 onto the barbed spine 27 to mount each cradle 41 and mirrored dish 39 onto the level 1 in a respective cut-out 29.

The multifaceted mirrored dish 39 comprises a central hub comprising a mirrored front face 43 and a mirrored top face 44 at 90° to one another. The front face 43 is parallel with the front 5 of the level 1, whilst the top face 44 is parallel with the base 3 and top 7 of the level 1.

A mirrored rear face 47 extends at 90° up from the top face 44 and leads, on one vertical side margin, to a multifaceted lateral mirrored portion comprising a first mirrored side face 49 the plane of which is at 45° to the plane of the front 5 of the level 1, but perpendicular to the plane of the base 3 of the level 1.

The first side face 49 leads to an outermost mirrored side face 51 the plane of which is perpendicular to the plane of the front 5 of the level 1 and perpendicular to the plane of the base 3 of the level 1.

The lower margin of the outermost side face 51 leads to an inclined mirrored lower side face 53 the plane of which is perpendicular to the plane of the front 5 of the level 1 but is at 45° to the plane of the base 3 of the level 1.

The lower margin of the inclined lower side face 53 leads to a horizontal mirrored base face 55 the plane of which is perpendicular to the plane of the front 5 of the level 1 but is parallel with the plane of the base of the level 1.

The other side margin of the rear face 47 leads to single faceted inclined planar lateral face 57 that extends to one side, and below, the rear face 47 and intersects the horizontal base face 55. The plane of the inclined lateral face 57 is angled at 45° to the plane of the front 5 of the level 1 and also at 45° to the plane of the base 3 of the level 1.

The three tubular vials 61, 62, 63, of each vial assembly 31, in this example each contain a different coloured liquid. The longitudinal axis of each vial 61, 62, 63 is orthogonal to that of the other two vials 61, 62, 63.

Each vial 61, 62, 63 has one end mounted in a central support 67, the support 67 extending through the hub 43, 44 of the mirrored dish 39 and being provided with a clip 66 that clips onto the cradle 41 or the spine 27 on the level 1. A pin or screw 68 may be inserted through the lower rear portion 11 of the level and into the lower end of the clip 66 to help resist removal of the support 67 from the cradle 41.

The other end of each vial 61, 62, 63 is provided with a respective end cap 69 that enables each vial 61, 62, 63 to be mounted on the mirrored dish 39.

The first vial 61 extends from the central support 67 to inclined side face 57 so as to be parallel with the longitudinal axis of the level 1 and parallel to the base 3. The second vial 62 extends from the central support 67 to the rear face 47 so as to be perpendicular to the longitudinal axis of the level 1 and parallel with the plane of the base 3. The third vial 63 extends from the central support 67 to the base face 55 so as to be perpendicular to the longitudinal axis of the level 1 and perpendicular to the plane of the base 3.

Thus in normal use of the level 1, the vial 61 is horizontal and is parallel with the top 7, base 3 and front 5 of the level 1. The vial 62 is also horizontal but perpendicular to the front 5 of the level 1. The vial 63 is vertical and parallel with the front 5, but perpendicular to the top 7 and base 3 of the level 1.

In the embodiment described, all of the faces 43-57 are mirrored so as to reflect images of the vials 61, 62, 63. Parts of each vial assembly 31 may alternatively be formed from a luminescent material of the type to store energy to release as light when the ambient conditions are dark. Such parts may include, for example, the hub 43, 44 and the vial end caps 69.

A protective cover 70 is also provided, in this example, comprising planar front and top portions at 90° to one another that protect the vial assembly 31 so as to be parallel with but slightly recessed from the front 5 and top 7 of the level 1. The vials 61, 62 and 63, and mirrored faces 43-57, are thus located below the cover 70. The cover 70 may comprise a lens to focus or enlarge an image of the or each vial 61, 62, 63.

The level 1 provides improved operation and the ability to level a surface about two axes simultaneously, whilst viewing the vial assembly 31 from single or multiple viewing angles—ie a user can level an item about two axes whilst looking at the level 1 in only one direction. The level 1 additionally provides multiple viewing angles for a given level orientation.

The level 1 may be used in a number of different orientations whilst usually providing visibility of two vials 61, 62, 63 for dual axis levelling. For example, the level 1 may be used with the base strips 3A 3B resting on the surface of an item to be levelled or with the front 5, top 7 or rear portions 13A, 13B resting on the surface. Additionally, the level 1 may be used with the rear planar portions 11, 15 abutting two right angled surfaces of an item to be levelled. The level 1 may additionally be used with the groove 3C on a rounded surface such as a pipe or diagonal apex, such as a frame.

With the level 1 in a first horizontal orientation, the base strips 3A, 3B of the level 1 rest on the surface of an item to be levelled. As can best be seen with reference to FIG. 7, vial 62 is out of sight when the user views the level 1 facing the front 5, that is, parallel with the plane of the base 3 but perpendicular to the plane of the front 5 of the level 1. Vial 61 is used to determine the angle of the level 1 from end 17 to end 19 of the level 1. A reflection of vial 62 is provided in at least first side face 49 and thus also enables the angle of the level 1 from front 5 to rear to be determined whilst still viewing the level 1 facing the front 5.

Again, with the level 1 in the first horizontal orientation with the base strips 3A, 3B of the level 1 on the surface of the item to be levelled, and with reference in particular to FIG. 8, the level 1 can be viewed from the front 5 and top 7 so as to look down on the level 1 at about 45°. Vials 61 and 62 can be seen, as can a reflection of vial 62 in inclined side face 57.

Again with the level 1 in the first horizontal orientation, the base strips 3A, 3B of the level 1 rest on the surface of the item to be levelled, and as can best be seen with reference to FIG. 9, vial 63 is not visible. Vial 61 is visible and is used to determine the angle of the level 1 between its ends 17, 19. In this orientation vial 62 levels from front 5 whilst vial 63 cannot be seen (although it can be seen in the second horizontal orientation described below). A reflection of vial 63 is provided in inclined lower side face 53 which also enables the angle of the level 1 between front 5 and rear to be determined when viewing the level 1 at a viewing angle parallel to the plane of front 5 (which is effectively the base of the level 1 when in this second horizontal orientation) and perpendicular to the top 7 (top 7 effectively being at the front with the level 1 in this second horizontal orientation).

A similar view may be achieved with the level 1 in a second horizontal orientation with the front 5 resting on the surface to be levelled.

The level 1 may also be used in a vertical, plumb, orientation. The recess 9 at the rear of the level 1 enables the level 1 to be placed against the edge of a door for example, such that the planar lower portion 11 rests against for example the front of the door, and the perpendicular portion 15 rests against the side of the door. The recess 9 thus provides enhanced location against two perpendicular surfaces whilst using only one hand to support the level 1. The level of both surfaces can be determined simultaneously from a single viewing angle due to the reflection of the vials 61, 62, 63 in the mirrored faces 44-57. This also applies if the level 1 is used horizontally with the recess 9 abutting the edge of a shelf or the like.

The level 1 may then be viewed along a viewing angle that is about 45° to the planes of the front 5 and top 7 of the level 1, as can best be seen with reference to FIG. 10. Vials 62 and 63 can be seen directly but an enhanced view is provided by images of vials 62, 63 in inclined lateral face 57. The level 1 may also be viewed along a viewing angle perpendicular to the plane of top 7, in which case vial 63 can be viewed directly and an image of vial 63 can be seen in first side face 49. The level 1 may additionally be viewed along a viewing angle perpendicular to the plane of front 5, in which case vial 63 can be viewed directly and an image of vial 62 can be seen in lower side face 53. Thus three independent viewing planes are provided for a single orientation of level 1.

With reference to FIG. 11, a modified vial assembly 31 is shown wherein the mirrored faces 49 and 53 are curved rather than planar. The curved faces 49, 53 enable the level 1 to be viewed from a number of different viewing angles in an arc about the longitudinal axis of the level 1 beginning at 90° to the top 7, passing through 45° to the top 7 and front 5, and ending at 90° to the front 5. The curved faces 49, 53 thus provide a wider range of viewing angles than was otherwise possible, and enable the vials 61, 62, 63 to be viewed more easily.

The provision of the cut-out 29 though both the front 5 and top 7 of the level 1 provides enhanced viewing of more than one vial 61, 62, 63, or vial image, simultaneously.

The cover 70 is optional and may be omitted.

It will be appreciated that other means of providing an image of each vial 61, 62, 63 may alternatively or additionally be provided. Such means could include a prism, a combination of a mirror and a prism, and/or electronic means such as a camera.

It will be appreciated that the particular angles and relative angles of the mirrored faces 44-57 described above are exemplary and that any other desired angles or relative angles could alternatively or additionally be used to achieve the desired viewing angles.

It is also envisaged that the mirrored surfaces could be arranged so that an image of a vial or vials is reflected from more than one mirrored surface to enable the image to be viewed. Thus an image provided by a composite mirror formed from a plurality of sequentially arranged mirrors is envisaged.

It is envisaged that any suitable type of vial could be used and that this could include, for example a tubular vial comprising a cylinder filled with liquid, or a block vial formed with an internal cylindrical cavity filled with liquid. By ‘longitudinal axis’ of the vial we mean the axis that passes through the two spaced apart markings on the vial in a direction perpendicular to the line of the markings.

1. A spirit level comprising a planar base that functions, with the level in a first orientation, as a first level face which rests, in use, on a surface of an item whose level is to be determined, the level being further provided with levelling means comprising first and second vials each filled with a liquid to form a bubble, the longitudinal axis of the first vial being substantially parallel to the plane of the planar base, the longitudinal axis of the second vial being substantially perpendicular to the longitudinal axis of the first vial, optical means being provided to provide an image of one of the vials such that the level of the surface can be determined about two axes, with the planar base resting on the surface of the item whose level is to be determined.

2. The level of claim 1 further comprising a planar front that functions, with the level in a second orientation, as a second level face for resting, in use, on a surface of an item whose level is to be determined.

3. The level of claim 1 wherein the optical means is arranged such that the level of the item about two axes can be determined simultaneously from a single viewing angle, both when the level is in a horizontal orientation, and when the level is in a vertical orientation.

4. The level of claim 1 wherein the optical means comprises a prism.

5. The level of claim 1 wherein the optical means comprises a mirror.

6. The level of claim 5 wherein the mirror is multi-faceted.

7. The level of claim 6 wherein the faces of the mirror comprise a plurality of intersecting faces.

8. The level of claim 6 wherein at least one face is inclined to the plane of the planar base, and to the plane of the planar front of the level.

9. The level of claim 8 wherein at least one face is inclined at substantially 45° to the plane of the planar base, and at substantially 45° to the plane of the planar front of the level.

10. The level of claim 6 wherein at least one face is substantially perpendicular to the plane of the planar base and inclined relative to the plane of the planar front of the level.

11. The level of claim 10 wherein at least one face is substantially perpendicular to the plane of the planar base and inclined at substantially 45° relative to the plane of the planar front of the level.

12. The level of claim 6 wherein at least one face is substantially perpendicular to the plane of the front of the 1 level and inclined relative to the plane of the base of the level.

13. The level of claim 12 wherein at least one face is substantially perpendicular to the plane of the front of the level and inclined at substantially 45° relative to the plane of the base of the level.

14. The level of claim 6 wherein the mirror comprises at least one planar face.

15. The level of claim 6 wherein the mirror comprises at least one curved face.

16. The level of claim 1 wherein the optical means includes a protective cover through which the vials can be viewed.

17. The level of claim 16 wherein the cover comprises a lens.

18. The level of claim 1 wherein the rear of the level is recessed so as to define a first rear planar portion the plane of which is substantially parallel with the plane of the front of the level, and a second rear planar portion the plane of which is perpendicular to the plane of the front of the level, the rear planar portions each comprising level faces operative to rest against a surface of an item to be levelled to enable the level of the item to be determined.

19. The level of any claim 1 wherein the levelling means comprises a third vial, the longitudinal axis of which is perpendicular to the longitudinal axes of the first and second vials.

20. The level of claim 19 wherein the longitudinal axis of the third vial is perpendicular to the plane of the base of the level.

21. The level of claim 1 wherein the vials are mounted on a common support such that the longitudinal axes of the vials intersect at the support.

22. The level of claim 1 wherein each vial is spaced along the longitudinal axis of the level so as to be relatively spaced apart, the optical means then comprising a respective optical sub means for each vial.

23. The level of claim 21 wherein the common support comprises mounting means operative to mount the support on the level.

24. The level of claim 23 wherein the level is formed with a protrusion, the mounting means of the support comprising a clip that clips onto the protrusion.

25. The level of claim 24 wherein the protrusion is barbed so as to be operative to enable the clip to be pressed onto the protrusion but to resist removal of the clip from the protrusion.

26. The level of claim 24 wherein the protrusion comprises a spine extending along the level in a direction parallel with the longitudinal axis of the level.

27. The level of claim 1 wherein the levelling means comprises a cradle mounted on the level, the cradle supporting the levelling means and the optical means.

28. The level of claim 27 wherein the cradle comprises a clip operative to clip onto the protrusion to mount the cradle on the level.

29. The level of claim 27 wherein the level comprises a cut-out formed in the planar front and the top of the level, the cradle being mounted in the cut-out.

30. A spirit level comprising a level face which rests, in use, on a surface of an item whose level is to be determined, the level further comprising levelling means comprising a vial filled with a liquid to form a bubble, the level face being recessed so as to define a first planar portion and a second planar portion the plane of which is perpendicular to the plane of the first planar portion, the planar portions each comprising level faces operative to rest against a surface of an item to be levelled to enable the level of the item to be determined.

31. A spirit level comprising a planar base that functions as a level face which rests, in use, on a surface of an item whose level is to be determined, the level being further provided with levelling means comprising a vial filled with a liquid to form a bubble, the longitudinal axis of the vial being substantially parallel to the planar base and perpendicular to the longitudinal axis of the level, optical means being provided to provide an image of the vial when the level is viewed in a direction parallel with the longitudinal axis of the vial.
